(19) United States
(12) Patent Application Publication
(10) Pub. No.: US 2024/0026721 A1
(43) Pub. Date: Jan. 25, 2024

(54) PIVOT DOOR ASSEMBLY WITH A ROLLER BOLT RAIL IN THE UPPER PORTAL STRIP

(71) Applicant: Bode - Die Tür GmbH, Kassel (DE)

(72) Inventors: Nils Gibhardt, Gudensberg (DE); Hans-Georg Brauer, Kaufungen (DE); Ulrich Arend, Dickershausen (DE)

(21) Appl. No.: 18/354,260

(22) Filed: Jul. 18, 2023

(30) Foreign Application Priority Data
Jul. 19, 2022 (DE) 20 2022 104 049.4

(51) Int. Cl. E05D 15/30

(52) U.S. Cl. CPC E05D 15/30; E05Y 2201/692; E05Y 2900/506; E05Y 2900/51; E05Y 2900/531; B61D 19/004

(57) ABSTRACT

A pivot door assembly for a vehicle with a door opening, includes a door leaf for opening and closing the door opening, and a rotary post assembly for displacing the door leaf between a closing position and an opening position. The rotary post assembly has a rotary post pivotable for displacing the door leaf. The door assembly also includes a rotary post lever for coupling the rotary post with the door leaf, wherein the door leaf has a roller bolt guided in a roller bolt rail. The pivot door assembly further includes an upper portal strip arranged in an upper horizontal region of the door opening. The roller bolt rail is arranged in the upper portal strip.

### CROSS-REFERENCE TO RELATED APPLICATIONS

This application claims the benefit of German patent application 20 2022 104 049.4 filed 19 Jul. 2022, the disclosure of which is incorporated herein by reference in its entirety.

### TECHNICAL FIELD

The disclosure relates to a pivot door assembly, in particular an internal pivot door assembly for a vehicle with a door opening that can be closed by means of a door leaf.

### BACKGROUND

Pivot door assemblies, and in particular internal pivot doors, are frequently used in public transport vehicles and low-floor vehicles, such as buses and trains.

For this purpose, pivot door assemblies conventionally have a portal frame in which at least one door leaf, frequently two door leaves, are guided. The pivot door assembly is often inserted into a door opening in an outer shell of the vehicle, using the portal frame as a separate sub-assembly.

For opening and closing the door opening, the door leaf is moved by a drive unit and guided by guiding members. The drive unit includes, for example, a rotary post moved by a hydraulic or pneumatic actuator. For this purpose, the drive unit is positioned in a sturdy drive unit carrier of the pivot door assembly. In order to be linked to the door leaf, the rotary post is connected to door leaf via a rotary post lever.

For guiding the door leaf, the door leaf is guided in a roller bolt rail via a roller bolt. The roller bolt rail is conventionally arranged in the drive unit carrier so that the roller bolt rail is capable of receiving the forces from the door leaf.

The drive unit carrier with the roller bolt rail is attached farther inside the vehicle, i.e. spaced apart from the outer shell of the vehicle, since the actuator mounted thereon takes up a certain space and has to control the rotary post via a lever with appropriate kinematics.

The roller bolt rail of the pivot door assembly makes an essential contribution to the kinematics of the moving door leaf. As the rotary post rotates about its own axis and sets the door leaf in motion, the roller bolt rail guides the roller bolt of the door leaf in a substantially linear manner and guides the door leaf in a stable manner during the opening or closing process.

However, the arrangement of the roller bolt rail on the drive unit carrier further inside the vehicle and spaced apart from the outer shell results in unfavorable kinematics of the door leaf, because during the opening or closing process, the door leaf temporarily protrudes a great distance from the door opening or the outer shell of the vehicle.

### SUMMARY

The pivot door assembly provides optimized kinematics for the door leaf. In this case, the kinematics or the door leaf are supposed to be inexpensive to produce. Moreover, the structure is supposed to be as simple and rugged as possible.

This is achieved by providing a pivot door assembly having the features of claim 1. Other particularly advantageous embodiments of the disclosure are disclosed by the respective dependent claims.

Accordingly, this is a pivot door assembly, in particular an internal pivot door, with a door leaf for opening and closing the door opening, and with a rotary post assembly for displacing the door leaf between a closing position and an opening position, wherein the rotary post assembly has a rotary post pivotable for displacing the door leaf, and a rotary post lever for coupling the rotary post with the door leaf. The door leaf has a roller bolt guided in a roller bolt rail, wherein the pivot door assembly comprises an upper portal strip arranged in an upper horizontal region of the door opening. According to the disclosure, the pivot door assembly according to the disclosure is characterized in that the roller bolt rail is arranged in the upper portal strip.

It must be noted that the features cited individually in the claims can be combined with each other in any technologically meaningful manner (also across the boundaries of categories, such as method and device) and represent other embodiments of the disclosure. The description, in particular in connection with the Figures, additionally characterizes and specifies the disclosure.

The door opening is incorporated into a wall of the vehicle. The wall is formed by an outer side of the vehicle and an inner side of the vehicle spaced apart from the outer side, so that the wall has a certain wall thickness due to the distance of the outer side from the inner side. The outer side may also be referred to as an outer shell. The door opening is incorporated as a cut-out into a wall of the vehicle and extends from the outer shell to the inner side. The door opening has a width extending in the horizontal direction and a height extending in the vertical direction. Due to the wall thickness, the door opening therefore also has a depth extending in the horizontal direction from the outer shell to the inner side, which, however, is much smaller than the width and the height and corresponds to the wall thickness of the vehicle.

The door opening can be closed or opened with one or several door leaves. For this purpose, the door leaf can be brought into a closed position, in which the door opening is closed, and an opening position, in which the door opening is not closed.

Generally, the contour of the door leaf is substantially rectangular. Therefore, the door leaf has a horizontally extending width, a vertically extending height and a certain thickness, which is much smaller than the width and the height. The thickness of the door leaf may correspond to the depth of the door opening, but does not have to. Since the door leaf has a thickness, the door leaf has inner and outer edges, wherein the outer edges are aligned with the outer shell of the vehicle in the closing position of the door leaf, while the inner edges are arranged with a horizontal offset in the direction towards the inside of the vehicle in the closing position of the door leaf. If the outer edges are aligned with the outer shell in the closing position of the door leaf, this is understood to mean that the door leaf is arranged so as to be aligned with the outer shell.

In order to move the door leaf between the opening position and the closing position, the pivot door assembly has a rotary post assembly with a rotary post. The rotary post is coupled to the door leaf by means of a rotary post lever. If the rotary post is rotated by a drive unit, the door is moved.

In order for the door to execute a certain movement, i.e. a pivoting movement, during opening and closing, the door leaf is additionally guided via guiding members. For guidance, a roller bolt in the form of a roller or of a wheel which is connected rotatably about an axis of rotation to the door leaf, is provided on the door leaf. The roller bolt is guided in a roller bolt rail which extends in a substantially linear manner.

The pivot door assembly comprises an upper portal strip. The upper portal strip is arranged in the upper horizontal region of the door opening, wherein this upper horizontal region of the door opening is located opposite a floor of the vehicle or of a door sill.

The upper portal strip is arranged in particular in the horizontal direction, at a distance from the outer shell of the vehicle in the direction of an interior of the vehicle of less than 5 cm, in particular less than 3 cm, and in particular less than 1 cam, and does not protrude from the outer shell of the vehicle.

The roller bolt rail is arranged in the upper portal strip. One core idea of the disclosure is that the roller bolt rail is arranged close to the outer shell of the vehicle so that the kinematics of the door leaf is improved. Due to the arrangement of the roller bolt rail close to the outer shell, the roller bolt has only a small distance from the door leaf, or may even be mounted in an aligned manner on the door leaf. Thus, the point of rotation in the form of the roller bolt about which the door leaf rotates when opening and closing, is arranged close to the primary closing edge of the pivot door assembly, so that the door leaf does not, or only to a very small extent, protrude from the outer shell of the vehicle during the opening and closing process.

The vertically extending edge which is at the front in the closing direction of the door is referred to as the primary closing edge of a door. When two door leaves are used, these are therefore the edges which abut against each other in the closed position of the door leaves; in the case of only one door leaf, the primary closing edge accordingly abuts against the vertically extending door opening edge in the closed position of the door. The vertically extending edge which is at the rear in the closing direction of the door is referred to as the secondary closing edge.

Another advantage of the disclosure is that the distance between the door leaf and the door leaf and the portal strip may always be uniform even for different vehicle models, which results in a smaller variance for the roller bolt and the roller bolt holder.

Compared with the conventional pivot door assembly of the prior art, in which the roller bolt rail is arranged on the drive unit carrier together with the drive actuator, the roller bolt rail in the pivot door assembly according to the disclosure is positioned on the upper portal strip and thus much closer to the outer shell of the vehicle than is the case in the prior art. At the same time, the roller bolt rail is also closer to the primary closing edge of the pivot door assembly. The kinematics of the door leaf are significantly by these factors.

In a preferred embodiment of the pivot door assembly, the roller bolt rail is arranged horizontally at a distance measured in the horizontal direction and perpendicularly to the outer shell of less than 10 cm from an outer shell of the vehicle.

In order to keep the temporary protruding of the door leaf from the outer shell of the vehicle during opening and closing small, one option is to choose a distance measured in a horizontal direction and perpendicularly to the outer shell of less than 10 cm between the axis of rotation of the roller bolt and the outer shell of the vehicle.

If, due to the structure, the distance can be reduced even more, this results in an even smaller extent of protrusion of the door leaf from the outer shell of the vehicle during the movement of the door leaf, with otherwise unchanged parameters of the lever mechanism of the door leaf. According to the disclosure, the distance is therefore, in particular, less than 8 cm, in particular less than 5 cm, and in particular less than 2 cm between the axis of rotation of the roller bolt and the outer shell of the vehicle.

For scalability, a distance between the axis of rotation and the outer shell of the vehicle that depends on the diameter of the roller bolt is also conceivable.

Therefore, the distance is, in particular, less than 8 times the diameter of the roller bolt, and in particular less than 5 times, 3 times or 1 times the diameter of the roller bolt.

In an advantageous embodiment of the pivot door assembly, the roller bolt rail extends in the upper region of the door opening along an upper horizontal edge of the door opening.

The upper horizontal edge of the door opening may be situated in the outer shell of the vehicle and be orientated, in particular, in the direction of travel of the vehicle. Opposite to it, a lower horizontal edge of the door opening is arranged, which is also arranged in the outer shell and which is a part of the floor of the vehicle or a part of a door sill of the door opening.

One option is to arrange the roller bolt rail not only along, but in particular parallel to, the upper horizontal edge because the roller bolt is thus guided, in particular in a linear manner, along the door opening.

In particular, the horizontal distance between the roller bolt rail and the upper horizontal edge is less than 8 cm, 5 cm or 2 cm. In particular, the distance in relation to the roller diameter is less than 8 times, 5 times, 3 times or 1 times the diameter of the roller bolt.

Advantageously, the roller bolt rail may be arranged above the door leaf and aligned with the door leaf in the closing position of the door leaf.

In the closing position, the door leaf is aligned with the outer shell of the vehicle without protruding from the outer shell of the vehicle. Thus, if the roller bolt rail is arranged above the door leaf and so as to be aligned therewith, the roller bolt rail is positioned directly on the outer shell of the vehicle without the roller bolt rail protruding from the vehicle or the outer shell thereof.

Therefore, the roller bolt is arranged, in particular, on top of the door leaf and aligned with the door leaf.

In an advantageous embodiment of the pivot door assembly, the roller bolt is arranged in the horizontal direction at a distance measured in the horizontal direction of less than 10 cm from an outer upper horizontal edge of the door leaf. For this purpose, the roller bolt may be attached to a roller bolt holder, by means of which the roller bolt can be attached to the door leaf with a space therebetween.

As was already described above, the contour of the door leaf is substantially rectangular. Therefore, the door leaf has a horizontally extending width, a vertically extending height and a certain thickness, which is much smaller than the width and the height. Accordingly, the outer upper horizontal edge of the door leaf is situated at an upper end of the door leaf and along the width of the door leaf, and is aligned with the outer shell of the vehicle in the closing position of the door leaf. Since the door leaf has a thickness, the door leaf also has in inner upper horizontal edge, which is parallel to the outer upper horizontal edge and which, compared with the outer upper horizontal edge, is not aligned with the outer shell in the closing position, but is offset in the direction towards the inside of the vehicle in the closing position of the door leaf.

Therefore, the outer upper horizontal edge of the door leaf mentioned herein is, in particular, that outer upper horizontal edge of the door leaf which is arranged so as to be aligned with the outer shell of the vehicle in the closing position of the door leaf. In this case, the distance of the roller bolt from the upper horizontal edge corresponds to the distance of the roller bolt from the outer shell of the vehicle, namely measured horizontally in the direction towards the inside of the vehicle if the door leaf is in the closing state. The distance can be selected such that the roller bolt is arranged within the outer shell of the vehicle.

The position of the roller bolt on the door leaf, together with the position of the roller bolt rail in the door opening, determines the movements and end positions of the door. Among other things, what is important is that the door leaf in its closing position ends flush with the outer shell of the vehicle. The roller bolt rail is supposed to be arranged as closely as possible to the outer shell or as closely as possible to the primary closing edge of the vehicle, because the kinematics of the door leaf is thus optimized such that the door leaf protrudes as little as possible from the outer shell while moving between the closing state and the opening state. Accordingly, the roller bolt must also be arranged as closely as possible to the outer shell of the vehicle, and thus, if possible, in the vicinity of the outer upper horizontal edge of the door leaf.

Therefore, the roller bolt is arranged, in particular, at a distance of less than 8 cm, less than 5 cm, or less than 2 cm from the outer upper horizontal edge of the door leaf. Expressed in relation to the diameter of the roller bolt, the distance is, in particular, less than 8 times, less than 5 times, less than 3 times or less than 1 times the diameter of the roller bolt.

Advantageously, the roller bolt is arranged so as to be offset in a horizontal direction by a distance of less than 10 cm from vertical outer edge of the door leaf.

In particular, the vertical outer edge of the door leaf is situated in the primary closing edge of the pivot door assembly. Thus, the roller bolt is arranged on the door leaf at a distance of less than 10 cm in the horizontal direction from the primary closing edge of the pivot door assembly.

By arranging the roller bolt close to the vertical edge or close to the primary closing edge of the pivot door assembly, the point of rotation of the door leaf about the axis of rotation of the roller bolt is arranged such that the door leaf does not, or only to a very small extent, protrude from the vehicle contour, i.e. the outer shell of the vehicle, during the opening and closing process.

Therefore, the roller bolt is arranged, in particular in the horizontal direction, at a distance of less than 8 cm, less than 5 cm, or less than 2 cm, from the vertical edge of the door leaf or from the primary closing edge of the pivot door assembly. Expressed in relation to the diameter of the roller bolt, the distance is, in particular, less than 8 times, less than 5 times, less than 3 times or less than 1 times the diameter of the roller bolt.

The roller bolt may preferably have a vertical axis of rotation. Due to a vertical orientation of the axis of rotation of the roller bolt and the door leaf standing vertically, the arising forces on the door leaf can be optimally transferred from the roller bolt into the roller bolt rail and absorbed by the latter.

Advantageously, the pivot door assembly may have sealing lip on the roller bolt rail, which seals the door opening towards the door leaf in the closing position of the door leaf. A gap, which permits the movement of the door leaf in the door opening without the door leaf grinding or hitting against the door leaf, is generally provided between the door leaf and the door opening. However, this results in the door opening not being sealed tightly in this region.

In the prior art, a brush or bristle strip, which is attached to the door opening and covers the gap between the door opening and the door leaf, is conventionally used for sealing this gap. For this purpose, the brush or bristle strip protrudes from the door opening over the door leaf. However, since the door leaf, when a conventional pivot door assembly is opened or closed, protrudes far from the outer shell of the vehicle and thus from the door opening, the brush or bristle strip has to yield to a correspondingly large extent, which increases wear significantly.

However, since the door leaf of the pivot door assembly according to the disclosure protrudes to a significantly smaller extent, or not at all, from the outer shell of the vehicle, an, in particular continuous, sealing lip made from rubber may advantageously be used in this region instead of a brush or bristle strip. In this arrangement, the wear of the sealing lip is significantly reduced compared with the wear of the brush or bristle strip of the prior art, and the gap between the door opening and the door leaf can be sealed better.

### BRIEF DESCRIPTION OF THE DRAWINGS

The present disclosure is explained in detail below based on exemplary embodiments with reference to the attached Figures. In the Figures:

FIG. 1 shows an exemplary door opening in a vehicle,

FIG. 2 shows a top view of a pivot door assembly from the prior art, with a roller bolt rail on a drive unit carrier in a closing position,

FIG. 3 shows the pivot door assembly from the prior art from FIG. 2 in a position between an opening and the closing position,

FIG. 4 shows the pivot door assembly from the prior art from FIG. 2 in the opening position,

FIG. 5 shows a top view of an embodiment of a pivot door assembly according to the disclosure, with a roller bolt rail arranged on an upper portal strip in a closing position,

FIG. 6 shows the embodiment of the pivot door assembly according to the disclosure from FIG. 5 in a position between an opening and the closing position,

FIG. 7 shows the embodiment of the pivot door assembly according to the disclosure from FIG. 5 in the opening position, and

FIG. 8 shows a side cross-sectional view of an upper portal strip with a roller bolt rail of the embodiment of the pivot door assembly from FIG. 5.

### DETAILED DESCRIPTION OF THE DRAWINGS

Unless otherwise stated, identical reference numerals in the Figures denote identical components, or components corresponding to one another with the same function.

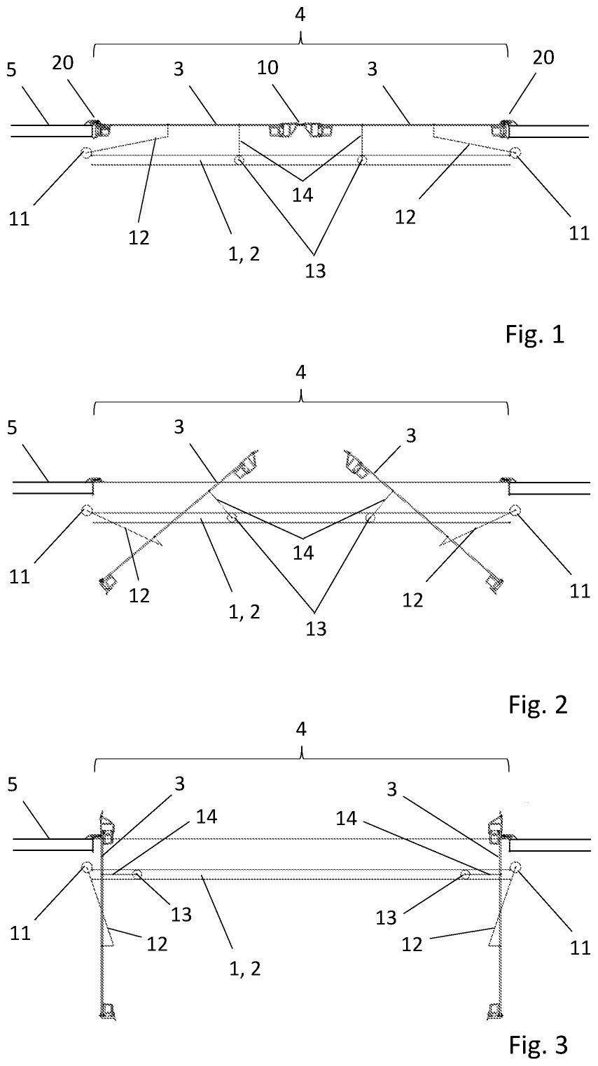

FIG. 1 schematically shows a door opening 4 closed by a pivot door assembly according to the disclosure with two door leaves 3. The door opening 4 is incorporated as a substantially rectangular cut-out in the outer shell 5 of the vehicle. Starting from the outer shell 5, the vehicle has a wall with a certain thickness 9, wherein the thickness is negligibly small in relation to a vertical height 7 and a horizontal width 8 of the door opening 4. The wall of the vehicle separates an interior space of the vehicle from its surroundings.

In this case, the upper horizontal region 15 of the door opening 4 is opposite a lower floor region 19 of the door opening. In this case, the floor region 19 corresponds to a door sill of the door opening 4.

The primary closing edge 10 is located between the two door leaves 3, and the secondary closing edges 20 are located between the vertical regions of the door leaves 3 and the door opening 4.

FIGS. 2 to 4 each show a top view of a pivot door assembly from the prior art, with a roller bolt rail 1 on a drive unit carrier 2.

The pivot door assembly comprises two door leaves 3 closing a door opening 4 of a vehicle. The two door leaves 3 form a primary closing edge 10, which is arranged at the front in the closing direction and at which the two door leaves 3 touch in the closed position. At the rear in the closing direction, the secondary closing edge 20 are arranged; in the closing position of the door leaves 3, they each touch an inner edge of the door opening 4.

To move the door leaves 3, the pivot door assembly has one rotary post 11 each for the door leaves 3. The rotary posts 11 are each connected to the door leaves 3 via a rotary post lever 12. The two rotary posts 12 are driven by actuators that are not shown.

In addition to the rotary post levers 12, the door leaves 3 have to be guided by further guiding members in order to execute a defined pivoting movement. For this purpose, roller bolts 13 are attached to roller bolt holders 14 on the door leaves 3, wherein the roller bolts 13 are supported so as to rotatable about axes of rotation 16. The roller bolts 13 are each guided in a roller bolt rail 1 firmly connected to the vehicle.

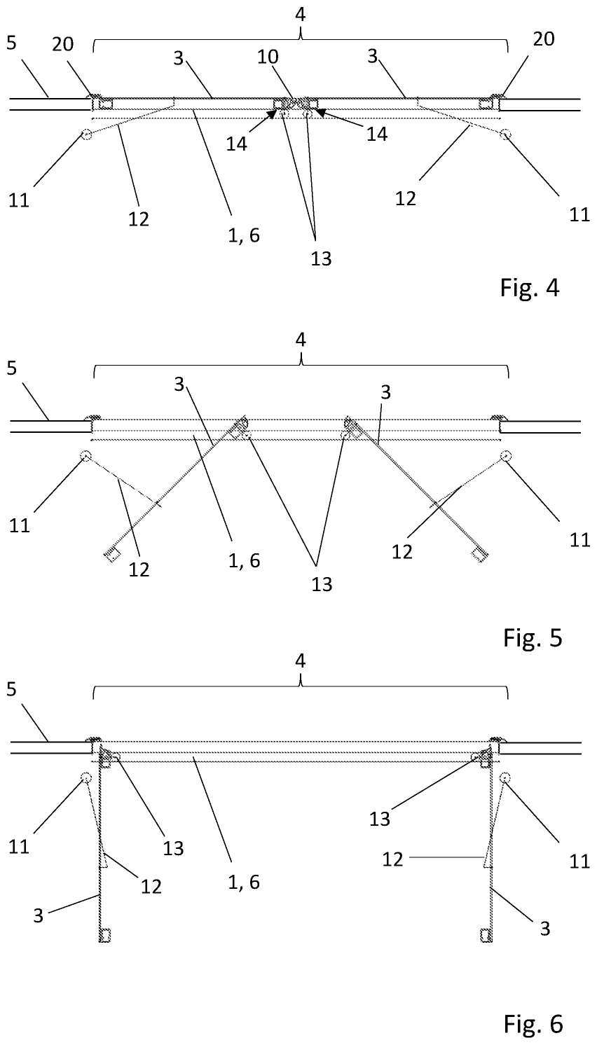

Up to this point, the basic structure of the pivot door assemblies from the prior art and of the embodiment of the pivot door assembly according to the disclosure shown in FIGS. 4 to 6 is designed in the same manner.

In FIG. 2, it can be seen that the roller bolt rail 1 is clearly spaced apart from the outer shell 5 of the vehicle on the drive unit carrier 2. This can be clearly gathered from the length of the roller bolt holder 14, for instance. In the horizontal direction, the roller bolt 13 is in each case spaced apart from the primary closing edge 10 of the pivot door assembly. The consequences of this arrangement of the roller bolt 13 relative to the primary closing edge 10 or the outer shell 5 of the vehicle for the kinematics of the door leaf 3 can be seen in FIG. 2.

FIG. 3 shows the pivot door assembly from the prior art from FIG. 2 in a position between the opening and the closing position. Due to the distance of the roller bolt rail 1 from the outer shell 5 of the vehicle or from the primary closing edge 10 and the, therefore correspondingly long, roller holder 14, the door leaf 3 in this position between the opening and the closing position swings significantly beyond the outer shell 5 of the vehicle.

FIG. 4 shows the pivot door assembly from the prior art from FIG. 2 in the opening position. The door leaves 3 protrude from the outer shell 5 also in the opened state of the pivot door assembly from the prior art.

FIGS. 5 to 7 each show a top view of an embodiment of a pivot door assembly according to the disclosure, in which a roller bolt rail 1 is arranged in an upper portal strip 6. Though the basic structure is very similar to the structure of the pivot door assembly from the prior art of FIGS. 2 to 4, nevertheless the structure according to the disclosure leads to clear advantages.

In FIGS. 5 to 7, the portal strip 6 and the roller bolt rail 1 coincide due to the schematic representation and are not depicted separately. It is apparent from FIG. 5 that the upper portal strip 6 is arranged close to the outer shell 5 and in the upper region of the door opening 15.

It can be seen that the roller bolt rail 1 is thus placed much closer to the outer shell 5 of the vehicle than in the pivot door assembly from the prior art, and the roller bolt holder 14 are kept correspondingly short. The roller bolt 13 is also arranged much closer the primary closing edge 10 of the pivot door assembly. The effects on the kinematics of the door leaves 3 can be seen in FIG. 6.

FIG. 6 shows the embodiment of the pivot door assembly according to the disclosure from FIG. 5 in a position between the opening and the closing position. In this position, the door leaves 3 protrude only to an insignificant extent from the outer shell 5 of the vehicle, so that in this regard, the kinematics of the door leaves 3 are significantly improved over the pivot door assembly from the prior art.

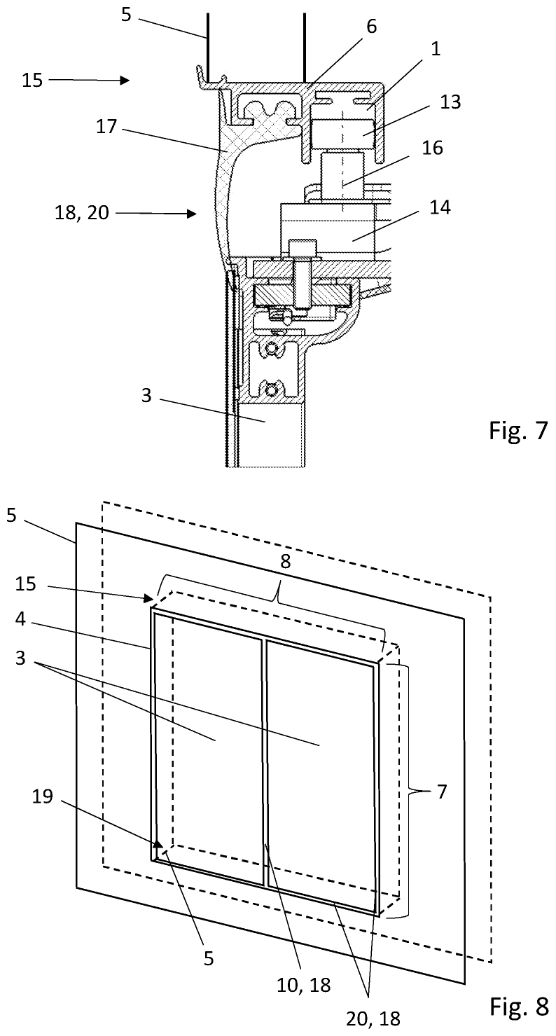

FIG. 7 shows the embodiment of the pivot door assembly according to the disclosure from FIG. 5 in the opening position. In the opening position of the pivot door assembly, the door leaves 3 advantageously no longer protrude from the outer shell 5 of the vehicle at all, in contrast to the embodiment according to the prior art.

FIG. 8 shows a side cross-sectional view of the upper portal strip 6 with a roller bolt rail 1 of the embodiment of the pivot door assembly from FIG. 5. The roller bolt rail 1 is a part of the upper portal strip 6, and thus close to the outer shell 5 of the vehicle. The roller bolt 13, which is rotatably supported on the axis of rotation 16, is guided in the roller bolt rail 1. Via the roller bolt holder 14, the roller bolt 13 is connected to the door leaf 3.

The upper portal strip 6 accommodates a sealing lip 17, which serves for sealing a gap 18 between the door leaf 3 and the door opening 4 in the closed state of the pivot door assembly. Since the door leaves 3 hardly protrude from the outer shell 5 in their movement between the opening and the closing position and in the process hardly deform the sealing lip 17, the sealing lip 17 can be given a correspondingly rigid configuration in order thus to achieve a better sealing effect.

1. A pivot door assembly for a vehicle with a door opening, the door assembly comprising: a door leaf for opening and closing the door opening, and with a rotary post assembly for displacing the door leaf between a closing position and an opening position, wherein the rotary post assembly has a rotary post pivotable for displacing the door leaf, and a rotary post lever for coupling the rotary post with the door leaf, wherein the door leaf has a roller bolt guided in a roller bolt rail, wherein the pivot door assembly comprises an upper portal strip arranged in an upper horizontal region of the door opening,
wherein
the roller bolt rail is arranged in the upper portal strip.

2. The pivot door assembly according to claim 1,
wherein
the roller bolt rail is arranged horizontally at a distance measured in the horizontal direction of less than 10 cm from an outer shell of the vehicle.

3. The pivot door assembly according to claim 1,
wherein
the roller bolt rail extends along an upper horizontal edge of the door opening.

4. The pivot door assembly according to claim 1,
wherein
the roller bolt rail, in the closing position of the door leaf, is arranged on the door leaf and aligned with the door leaf.

5. The pivot door assembly according to claim 1,
wherein
the roller bolt is arranged at a distance of less than 10 cm in the horizontal direction from an outer upper horizontal edge of the door leaf and, the outer upper horizontal edge is arranged so as to be aligned with an outer shell of the vehicle in a closing position of the door leaf.

6. The pivot door assembly according to claim 1,
wherein
the roller bolt is arranged so as to be offset in a horizontal direction by a distance of less than 10 cm from primary closing edge of the pivot door assembly.

7. The pivot door assembly according to claim 1,
wherein
the roller bolt has a vertical axis of rotation.

8. The pivot door assembly according to claim 1,
wherein
a sealing lip, which seals the door opening towards the door leaf in the closing position of the door leaf, is arranged on the roller bolt rail.
